(19) United States
(12) Patent Application Publication
(10) Pub. No.: US 2007/0287413 A1
(43) Pub. Date: Dec. 13, 2007

(54) Method and system for mobile billing and content delivery

(76) Inventors: Andrew H. Kleitsch, Burien, WA (US); Jeffrey J. Upthegrove, Burien, WA (US)

Correspondence Address: NEAL MARCUS, ESQ., 333 W. HUBBARD STREET, # 3-D, CHICAGO, IL, 60610, US

(21) Appl. No.: 11/449,357

(22) Filed: Jun. 7, 2006

(51) Int. Cl. H04M 11/00

(52) U.S. Cl. 455/405; 455/466

(57) ABSTRACT

A method of billing is provided for mobile content purchased by a customer, the method comprising the step of generating a text message with a notification relating to a purchase by a customer of mobile content. The text message includes a web link linking the text message to a receipt with information relating to the purchase of the mobile content.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF INVENTION

The present invention relates generally to a system and method for mobile billing and content delivery.

Mobile devices such as cell phones, smart phones, PDA's etc. have become an integral part of peoples' lives. The ability of mobile devices to perform multiple functions has transformed the way we live and work. Mobile devices now commonly perform a host of tasks beyond traditional voice communication including email and text messaging, instant messaging, music playing, word processing and web (online or internet) searching or surfing, i.e., receiving mobile web content (“mobile content”). The market demand for mobile content is increasing at an exponential rate. This is particularly true for premium content. Premium content is any type of content that is offered for sale (single use or by subscription). Presently, most mobile transactions are conducted by mobile operators (i.e., mobile providers or carriers) using their own integrated billing systems. In such systems, mobile content is offered through the operator's own (mobile) portal web page. For the customer who purchases mobile content through the operator's portal page, the charges will subsequently appear on the customer's monthly operator bill. Merchants offering and delivering the actual premium content (through the operator's portal page) are paid according to a revenue sharing arrangement they have with the operators. In addition to mobile operators, there are several other companies that offer premium mobile content (of merchants) through their own company portals. A similar revenue sharing arrangement exists between portal company and a merchant.

Alternatively, operators offer certain premium mobile content to customers through another integrated billing system. This system incorporates a text messaging process for providing desired premium content. If mobile content is desired, the customer sends a text message to a merchant (as advertised). The customer typically addresses the text message with a number advertised by the merchant. The return text message may include the desired content within the message (e.g., ring tone) or may include a direct link to access the content. The operator typically employs the services of one or more third party messaging aggregators to act as an interface between the user and operator. The aggregators are essentially distribution partners for the operators. Aggregators are the primary method of ensuring that the operator receives the customer's text message and customer receives the return message from the operator. The operator may also employ a mobile billing manager for managing the billing process for the operator. Nevertheless, similar to the billing process above, the operator bills the customer for the desired content in the customer's monthly invoice, and the merchant is paid according to a revenue sharing arrangement with the operator.

Whether a merchant chooses an operator's (or third party) portal or the text messaging process for premium content distribution, the integrated billing systems described above are extremely disadvantageous. For one thing, the merchants are subject to debilitating billing policies. Mobile operator integrated billing systems charge transaction fees of 35%-50% and burden content owners with payout terms of 90 days or more. Additionally, the merchants must adhere to the operator's content guidelines and restrictions. Operators typically prohibit the distribution of assorted mobile content including various ring tones, music and video clips, and other adult or mature themed content. These guidelines and restrictions effectively block many global content owners (merchants) from entering the premium mobile content market. For these reasons, merchants have become quite dissatisfied with mobile operator integrated billing systems. Merchants therefore seek alternatives for mobile content distribution. One alternative is to market mobile content outside operator or carrier network (portal) integrated systems (“off portal”). Over the years, off portal sales have increased dramatically and are expected to continue. With off portal operation, customer personal information is entered through a web site or by cell phone. The customer credit card is charged and login information (e.g., user name and password) is provided (or chosen by the customer) along with a URL for accessing (viewing) the mobile content from a browser on a customer's mobile device. In order to view the mobile content, the customer must enter the URL address into his/her mobile device along with the login information. This process is cumbersome, and the customer may not even gain access to desired mobile content. However, the customer is charged for this service regardless of whether he/she has successfully viewed the desired mobile content. Charge-backs and refunds are expensive to the content provider and are frequently difficult and time consuming to obtain.

In sum, it would be desirous to offer a solution that would overcome the disadvantages of the systems and processes above.

### SUMMARY OF THE INVENTION

In accordance with an embodiment of the present invention, a method of billing is provided for mobile content purchased by a customer, the method comprising the step of generating a text message with a notification relating to a purchase by a customer of mobile content, the text message including a web link linking the text message to a receipt with information relating to the purchase of the mobile content.

In yet another embodiment of the present invention, a method is provided of billing for mobile content, the method comprising the steps of: receiving payment information from a customer for the purchase of mobile content; processing the customer payment information; authenticating automatically the customer's right to view the mobile content prior to the customer's receipt of the mobile content.

In another embodiment of the present invention, a method is provided of supplying mobile content to a mobile device of a customer, the steps of the method comprising: receiving customer payment information for the purchase of mobile content; and transmitting a text message to the customer's mobile device as a notification of approval of the purchase, the message including a web link linking the message to a receipt relating to the purchase, the web link in the message thereby enabling the customer to view the receipt through the customer's mobile device, the receipt including a receipt ID relating to the purchase and a web link linking the receipt to the purchased mobile content, the web link in the receipt thereby enabling the customer to view the purchased mobile content through the customer's mobile device.

In yet another embodiment, a method is provided for supplying mobile content to a mobile device of a customer, the method comprising the steps of: receiving customer credit card information to purchase the right to view the mobile content through the customer's mobile device; transmitting a text message to a customer's mobile device, the message including a web link linking the message to a receipt relating to the purchase, the link thereby enabling the customer to view a receipt through the customer's mobile device, the receipt including a web link linking the receipt to the mobile content, the web link thereby enabling the customer to view the mobile content through the customer's mobile device; and charging the customer's credit card for the right to view the mobile content only when the customer has successfully viewed the mobile content on the customer's mobile device.

In yet a further embodiment of the present invention, a billing system is provided for mobile content purchased by a customer, the system comprising: a server forwarding a text message to a mobile device of the customer, the text message including a notification approving a purchase by the customer of mobile content.

### BRIEF DESCRIPTION OF THE DRAWINGS

The accompanying drawings, which are incorporated herein and constitute a part of the specification, illustrate embodiments of the invention, and together with the general description given above and the detailed description of the embodiments given below, serve to explain the principals of the invention.

FIG. 1 illustrates a network incorporating a mobile billing and content delivery system and method in accordance with an embodiment of the present invention.

FIG. 2 is a flowchart illustrating the high level steps of the billing and content delivery method in accordance with an embodiment of the present invention.

FIGS. 3A and 3B are flowcharts illustrating the detailed steps of the billing and content delivery method in accordance with an embodiment of the present invention.

FIG. 4 illustrates a text message purchase notification in accordance with an embodiment of the present invention.

FIG. 5 illustrates a purchase receipt in accordance in accordance with an embodiment of the present invention.

FIG. 6 illustrates a customer account information web page in accordance with an embodiment of the present invention.

### DETAILED DESCRIPTION OF THE INVENTION

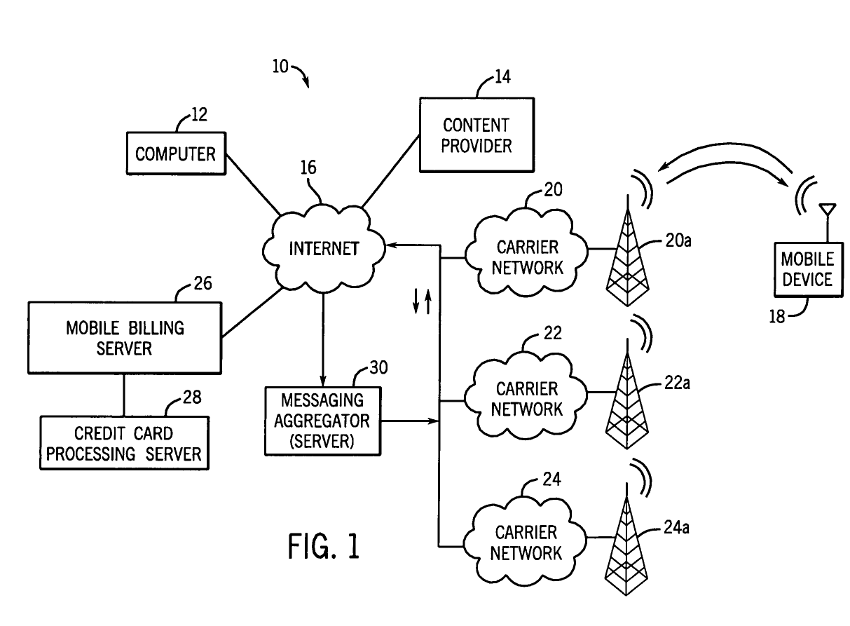

In FIG. 1, there is shown a diagram of network 10 in accordance with an embodiment of the present invention. Within network 10, a user or customer at computer 12 may access online content from content provider 14 or any other desired content from a merchant's web server(s) through internet 16. If content provider 14 decides to offer some or all of its online content remotely, in proper format, to mobile devices (“mobile content”) such as mobile device 18, content provider 14 will employ the networks of the mobile operators (or carrier networks) such as carrier networks 20, 22, 24 to accomplish this task. Although three carrier networks (carriers networks 20, 22, 24) are shown, content provider 14 may employ other carrier networks to provide mobile content to customers. Mobile devices include cell phones, smart phones, PDAs and other devices that allow a customer to communicate through the carrier networks. Content provider 14 includes a web server along with other servers hosted by the content provider.

As is known by those skilled in the relevant arts, carrier networks 20, 22,24 each include as part of their network a mobile tower (20a, 22b, 24c) and a Wireless Application Protocol (WAP) gateway to enable WAP-enabled mobile devices to communicate to web sites and web applications over internet 16. In short, the WAP gateway provides wireless networks with Internet access and optional content translation and filtering. Carrier networks 20, 22, 24 each incorporate a proxy server to act as the WAP gateway. In this respect, the proxy server manages the communication between the mobile device and Internet server(s). The proxy server caches internet content and sometimes even translates raw HTML into WAP compatible protocols such as wireless markup language (WML). WML is essentially a subset of Hypertext Markup Language (HTML) with roots in Extensible Markup Language (XML). In operation, web sites deliver pages in WML that is compiled and forwarded by the WAP gateway to mobile devices. WML is the dominant language in use with wireless devices today. However, other mobile browser compliant languages are used such as cybertown markup language (CTML) and physical markup language (PML).

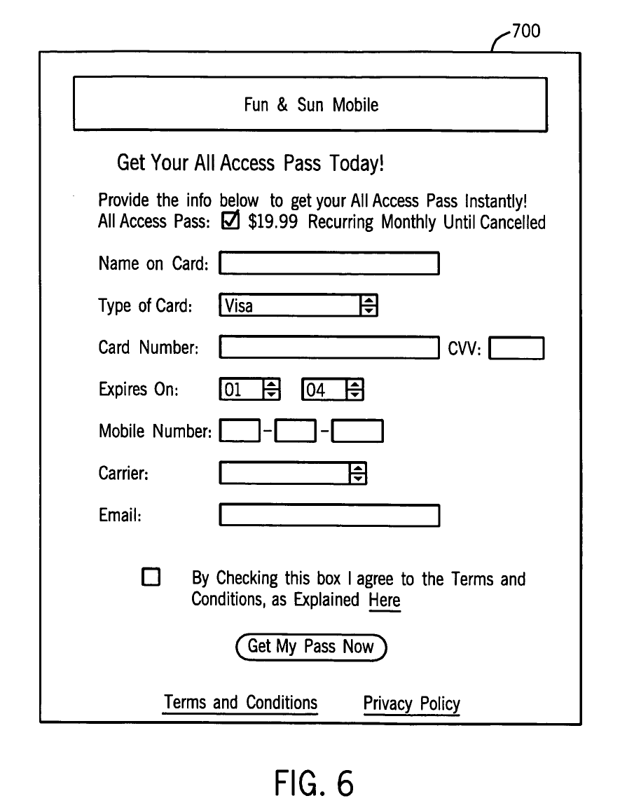

In the event a content provider 14 decides to offer (sell) premium content to customers through customer mobile devices, content provider 14 will advertise this service on its web site along with an HTML link. An example of this advertisement may be banner advertising a biker mobile video for $3.99 on bikerworld.com, the content provider's web site. When the potential customer clicks on the advertisement, the corresponding link will take the customer to a purchase page or customer account web page (e.g., go.mobilebilling.com) wherein customer account information is entered. Along with other functions, mobile billing and content delivery server 26 (on network 10) hosts the customer account information web page and stores customer account information. Mobile billing and content delivery server 26 is hereinafter “mobile billing server 26” or “customer account web server 26.” (Mobile billing server 26 performs the function of mobilizing or converting the online content into a mobile format for distribution to mobile devices. However, content provider 14 may alternatively perform this function, as discussed below.) An embodiment of the customer account information web page for entering such customer account information is shown in FIG. 6. In brief, the customer enters his/her name, credit card information (e.g., credit card type, number and expiration date), mobile number and carrier network name. That information is processed by credit card processing server 28. Credit card processing server 26 uses the services of financial institutions (credit card companies/banks) for validating credit card information and charges. In one embodiment, mobile billing server 26 is responsible for all billing functions of a transaction involving premium content and mobilizing (converting) the content from content provider 14 into a format suitable for distribution. However, mobile billing and credit card processing may alternatively be hosted by content provider 14 (itself).

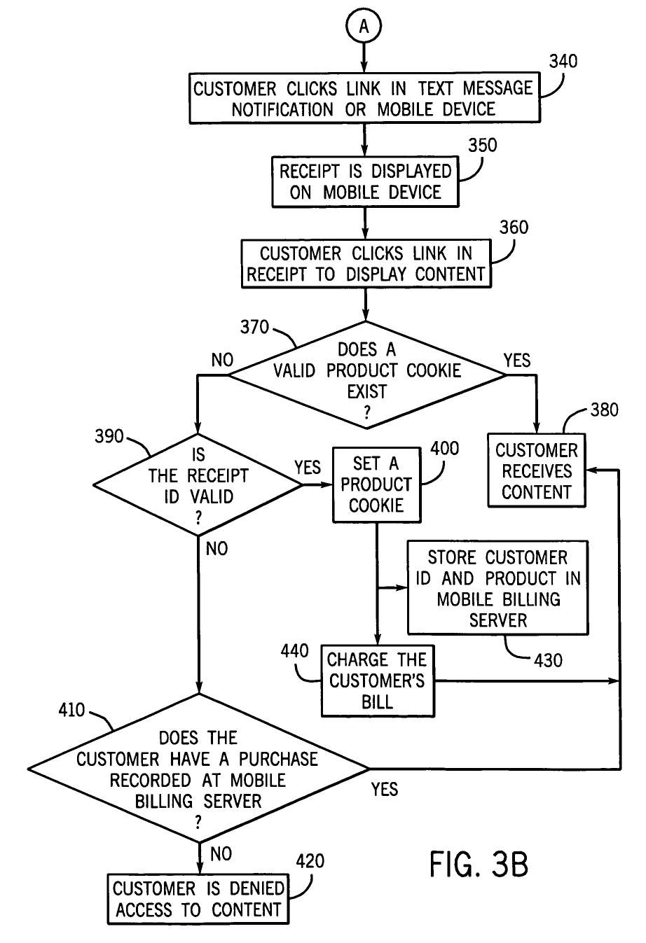

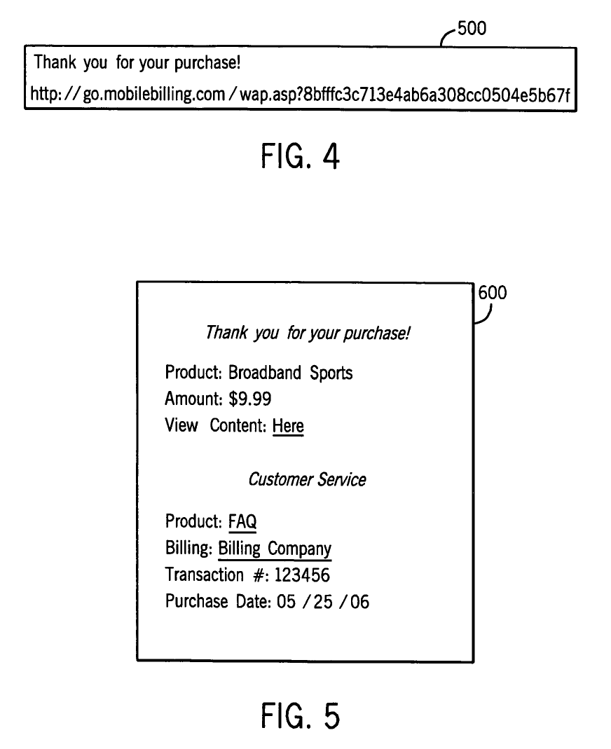

Now, upon credit card validation, mobile billing server 26 sends a text message to mobile device 18 as a form of notification or confirmation of acceptance of the transaction (i.e., notification of the success of the purchase of premium content or right to view the mobile content). The text message may be in the form of a WAP push, SMS or SMTP message. This text message is “content neutral.” That is, the text message does not contain premium content (or any content) or a direct web link to such content. The text message merely incorporates a web link that links, points or redirects the customer via internet 16 to a receipt stored on mobile billing server 26 relating to the purchase. Mobile billing server 26 generates this receipt and sends it to messaging aggregator 30, as discussed below. The text message may also include minimal text acknowledging the purchase. A form of the notification text message is shown in FIG. 4 and the receipt is shown in FIG. 5. However, charging does not occur until the receipt is validated. This is discussed in more detail below.

The receipt includes information such as the product name, a content link (URL) to the purchased content with an appended transactional or receipt ID and one or more token ID(s). A customer may have purchased several products under one charge (single receipt). For each use of a product, a unique token ID may be generated, as discussed in more detail below. The receipt also includes a customer service link (URL) and a product FAQ link (URL) to contact information and answers to frequently asked questions. The receipt ID stored on the mobile billing server 26 will subsequently be used for authentication purposes. In normal operation, the carrier networks each generate a unique ID for each customer. This customer ID is located in a WAP header embedded at the front end of the mobile content. The customer ID is also used for authentication purposes. Once a receipt ID is authenticated, the receipt ID stored in billing server 26 is deleted, and a cookie is installed within the browser on mobile device 18. The mobile billing server 26 provides the content for the cookie. The cookie includes the product name (purchased) and a time stamp (i.e., expiration date or duration of product use). The cookie is used to enable a customer to view the purchased mobile content through the time stamp for this cookie (through subscription expiration date). Once a cookie is set, the customer ID and product (identity) are stored in a database within mobile billing server 26 and the customer is charged. However, the customer ID may be stored in a database on the content provider 14 if content provider performs the mobile billing and content delivery (including mobilizing or converting). Once that date expires, the cookie is deleted and the customer is prevented from viewing the mobile content. In the event a customer purchases premium mobile content for single or one time viewing, no cookie is installed on mobile device 18. The authentication process above including details of the receipt ID, customer ID and cookies is described below.

Mobile billing server 26 sends a text message to messaging aggregator 30, and messaging aggregator 30 forwards the text message to carrier networks 20, 22, 24 for transmission to mobile device 18. Mobile billing server 26 uses messaging aggregator 30 because it (aggregators) is bound to the carrier networks (20, 22, 24).

It should be noted that customer account information may alternatively be entered through the mobile device 18 using an interface voice response (IVR) that is maintained by a third party. In this respect, premium content is marketed through various channels along with a 1-800-number. The customer calls the number. The customer selects the product for purchase and verifies his/her mobile phone number. The voice form gathers customer information. The customer agrees to the terms of service and price for premium content. Mobile billing server 26 processes credit card information using credit card processing server 28. The customer may hear either (1) payment success (e.g., Thank you for your purchase. “See phone for message” or (2) payment denied (e.g., “sorry, try again.”). Once the customer hangs up, a text message purchase notification is sent to mobile device 18 (provided the payment was a success). The remaining process described above with respect to the notification text message, receipt, and billing applies to this customer account information entry process.

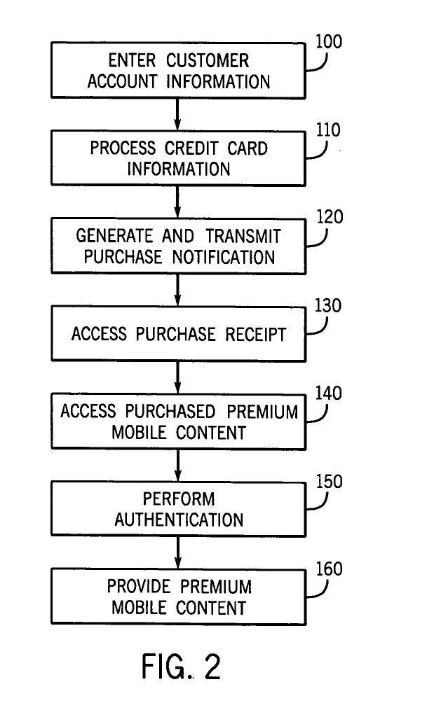

FIG. 2 is a flowchart illustrating the “high level” steps of the mobile billing and content delivery method in accordance with an embodiment of the present invention. At step 100, a customer enters his/her customer account information via a customer account web page (after clicking on a premium mobile content advertisement appearing on content provider's 14 web site) or via an IVR over mobile device 18. As described above, the customer account information includes his/her name, credit card account information (e.g., credit card type, number and expiration date), mobile number and carrier network name. That information is processed by credit card processing server 28 at step 110 and stored. The processing involves the services of a credit card company or bank. At step 120, a text message is generated as a purchase notification and transmitted to mobile device 18 (using the services of mobile billing server 26, messaging aggregator 30 and the relevant customer carrier networks 20, 22, 24). At step 130, the customer clicks on the link in the notification text message to access/view, via internet 16, his/her purchase receipt stored on mobile billing server 26.

As indicated above, the receipt includes information such as the product name, a content link (WAP URL) to the purchased premium mobile content with an appended transactional or receipt ID and one or more token ID(s). A customer may have purchased several products under one charge (single receipt). For each use of a product, a unique token ID may be generated, as discussed in more detail below. The receipt also includes a customer service link (URL) and a product FAQ link (URL) to contact information and answers to frequently asked questions. At step 140, the customer clicks the content link (URL) to view the premium purchased content. Before the content is transmitted for display, authentication of the purchase (i.e., the customer's right to view the mobile content) and subscription (i.e., right to view it subsequently), is performed as required at step 150 using the receipt ID, customer ID and cookie as mentioned above. The customer ID is an arbitrary ID generated by the carrier network/operator. The customer ID is found in the WAP header embedded at the front end of the mobile content. This step is described below in more detail. Once authentication is performed, the customer's credit card is charged and premium mobile content is transmitted at step 160 to the customer's mobile device such as mobile device 18 for display. As indicated above, mobile billing server 26 performs the function of mobilizing or converting the online content into a mobile format for distribution to mobile devices. However, content provider 14 may alternatively perform this function, as discussed below.

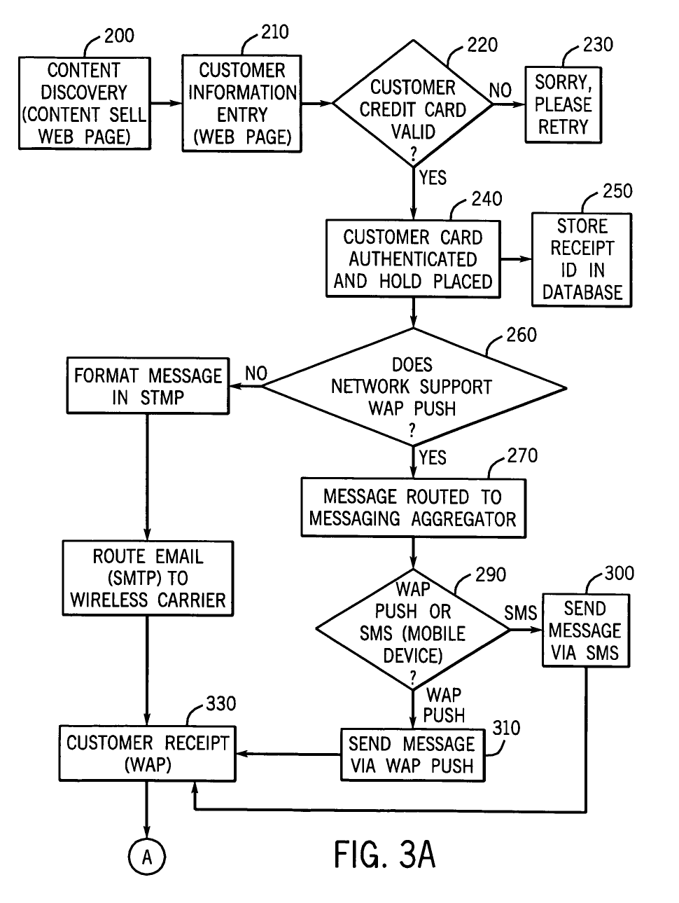

FIGS. 3A and 3B are flowcharts illustrating the detailed steps of the mobile billing and content delivery method in accordance with an embodiment of the present invention. Referring to FIG. 3A, the flowchart begins at step 200 wherein a customer discovers mobile content on a content sell web page that he/she wishes to receive through his/her mobile device. A customer may be at his/her computer surfing the web and notice an advertisement on a favorite online website for mobile content, e.g., bikerworld.com. This is the content sell web page and it is hosted (or populated) by content provider 14. Behind the scenes, the content sell web page includes information such as a product description, the product price, a content link (WAP URL), customer service web link (URL), and a product FAQ URL. The content sell page also includes a web link (URL). The web link (URL) is used to redirect the customer back to the sell page after the customer has made a purchase via a customer on his/her computer through the customer account page. This information is used to generate an applicable receipt, as discussed in detail below. The user then clicks on the advertisement and the underlying link (https://mobilebilling.com/bikerworld/default.asp) takes the customer to a customer account information web page on mobile billing server 26. In this page, there are input fields displayed for customer information including the credit card details (e.g., name on card, card number and expiration date), mobile number, carrier network and possibly other information such as email address.

At step 210, the customer enters his/her relevant information and mobile billing server 26 stores the information. Execution moves to decision diamond or step 220 wherein a decision is made whether the customer credit card is valid. This task is conducted by credit card processing server 28 along with the services of the relevant credit card company or bank to validate the information and charges. As is understood by those skilled in the relevant arts, credit card processing server 28 includes an application protocol interface (API). The API enables mobile billing server 26 to charge or refund the customer's account. If the credit card is not valid, the potential customer is advised “Sorry, Please Retry” at step 230. If the credit card is validated, execution moves to step 240 wherein the customer card is authenticated and placed on hold. The card, however, will not be charged at this time. At this stage, mobile billing server 26 generates a receipt along with a transaction or receipt ID (e.g., 12345) and one or more tokens. For multiple products on one purchase (receipt), there may be multiple uses or token IDs that are generated. For example, a customer might purchase three ring tones for $5.99. Only one purchase is made at $5.99 and charged to the customer's credit card. Hence, there is one receipt and one receipt ID. However, each product use may have a unique token ID generated. The receipt also includes the product price, a content link (WAP URL), a customer service link (URL) and product FAQ link (URL). At step 250, the receipt is stored in a database on mobile billing server 26 for later use.

Execution of the process moves to decision step 260 wherein a decision is made whether the relevant carrier network and customer mobile device supports WAP push. WAP push messages are specially formatted short message service (SMS) messages. WAP push messages are desirable because they display an alert message to the user, and give the user the option of connecting directly to a particular URL via the mobile phone's WAP browser. (Not all SMS messages allow a link to be “clicked.”) However, certain carrier networks do not support WAP push messages. Now, if the answer is yes to decision step 260, a text message is generated as a notification of the purchase as described above and routed to messaging aggregator 30 at step 270 for transmission via the relevant carrier network. Aggregator 30 acts a distribution partner for the carrier networks 20,22,24. Messaging aggregator 30 compensates the carrier networks, and the merchants (content providers) compensate the messaging aggregator 30.

At this stage, a decision is made whether mobile device 18 is capable of receiving a WAP push message or only a standard SMS at decision step 290. However, if it is decided that mobile device 18 cannot support a WAP push message, then an SMS message (notification) is sent and received by the customers at steps 300 and 330, respectively. If a WAP push message is supported, however, the message is sent via WAP push and received by the customer at steps 320 and 330, respectively. Now, if either the carrier network or mobile device does not support WAP push at step 260, then a message is formatted in an SMTP email format at step 280 and the resulting message email is routed to the wireless carrier network as a text message at step 320. As is understood by those skilled in the relevant arts, a mobile message is sent over an SMTP email server, and that server captures the message and sends it as a text message. (e.g., email message “mobilenumber@mymobileoperator.com”) is sent and converted into a text message.) The HTML encoded email message is reformatted (stripped) and sent via a carrier network as an SMS. Returning to FIG. 3A, the customer receives the SMTP text message at step 330. At this point, carrier networks 20, 22, 24, mobile billing server 26 and content provider 14 of network 10 remain idle until the customer clicks on the link within the text message to view the mobile content.

Turning now to FIG. 3B, execution moves to step 340 wherein a customer clicks on the link within the text message (purchase notification) on the customer's mobile device. Note that the text message notification is content independent. It contains only a link to a receipt and maybe some minimal language concerning the purchase. Because the message is content neutral, the likelihood that the message will comply with the operator/carrier network rules, policies and restrictions is increased. At this point, the components within network 10 are unaware of whether a customer is attempting to view mobile content for the first time or multiple times during a subscription. Upon a customer's click on the web link in the notification, a browser on mobile device 18 accesses and displays the stored purchase receipt at step 350. Then, the customer clicks on the content web link in the receipt to view the mobile content at step 360. At this point, a decision must be made at step 370 of whether a valid product cookie exists, i.e., whether a valid cookie is set on the customer's mobile browser. As indicated above, the cookie contains the product name and a cookie expiration date (i.e., subscription expiration date). The product purchased (stored receipt) is compared with the product stored in the cookie. If a valid cookie exists, i.e., if the product purchased matches the product set in the cookie, the customer is permitted to access and view the purchased premium content at step 380. As indicated above, mobile billing server 26, acting as the mobile content provider (mobilizing and converting content for content provider 14), generates the cookie and installs it at the front end of the mobile content. Once a cookie reaches the expiration date, the browser deletes the cookie.

Now, if a valid product cookie does not exist (no matching product cookie or no cookie at all), execution moves to step 390 wherein a decision is made whether the receipt ID is valid. In order to accomplish this task (complete decision), the database on mobile billing server 26 is searched for an ID associated with the purchase that matches the receipt ID. If a matching receipt on the database is found, the receipt ID is validated, and the receipt ID stored in database within mobile billing server 26 is deleted. Execution then moves to step 400 wherein a product (i.e., mobile content) cookie is installed in a WAP browser on mobile device 18. Note that mobile billing server 26 controls the content of the cookie and inputs the cookie at the front end of the mobile content. Note also that a mobile device may have several cookies relating to several products installed in its WAP browser. (If the customer purchases mobile content for only one viewing, then no cookie is provided in the mobile content). Once the cookie is installed, the customer is “logged in” and the customer ID from the WAP header (mobile content) and product identity are stored in mobile billing server 26.

Now, if the receipt ID is not valid, then execution moves to decision step 410 wherein a decision is made whether the customer has a purchase recorded (stored) at the mobile billing server 26 (or alternatively the content provider 14 if it performs the mobile billing, converting/mobilizing and delivery). Note that a receipt may not be valid but a customer may very well be authorized to view the purchased mobile content. For one thing, the customer may be viewing the content multiple times. In this respect, the receipt would not be validated because the receipt originally stored in the database within mobile billing server 26 has been deleted upon the customer's first attempt to view the desired content.

In order to accomplish this task (step 410), the customer ID from the WAP header (embedded in mobile content) is compared with the customer ID stored in the mobile billing server's 14 database (or alternatively the content provider server 14 if the provider/merchant wishes to handle the mobile billing and content delivery functions). If the customer ID from the WAP header does not match the customer ID stored, then the customer is denied access to content at step 420. If the customer ID's match, then the customer receives the premium mobile content at step 380 from mobile billing server 26. As indicated above, mobile billing server 26 performs the function of mobilizing or converting the online content into a mobile format for distribution to mobile devices. However, content provider 14 may alternatively perform these functions.

Returning to decision step 390, if the receipt ID is validated, a product cookie is set in the customer's mobile device browser at step 400. At step 430, the customer ID and product name are stored in the database within mobile billing server 26. Execution then moves to step 440 wherein the customer credit card is now charged for the product purchase. Once it is known that the customer has successfully received the receipt, the customer then receives the premium content through the customer's mobile device 18 at step 380.

If a customer purchases a recurring subscription, the process in FIGS. 3A-3B is reinitiated starting at step 220 (e.g., credit card processing, text message transmission, etc.). However, customer credit card information does not need to be entered a second time unless the customer credit card processing denies the recurring purchase and he/she needs to enter in new customer information. The length of a recurring subscription (reinitiating) varies as desired for the content. Reinitiating may occur monthly, weekly or any other duration. Recurring subscriptions are repeated until cancelled (voluntarily or involuntarily, e.g., credit card expired). In short, recurring subscriptions are built into the process.

With respect to FIGS. 3A and 3B, the process described incorporates two types of authentication. In the first type, a customer's purchase (i.e., right to view the mobile content) is authenticated. Authentication occurs when the customer attempts to view the mobile content (when customer clicks the link in receipt). The receipt ID (from the receipt) is compared to the receipt ID for the purchase stored in mobile billing server 26. The second type of authentication essentially involves the subscription confirmation. This type incorporates the use of a cookie and customer ID to ensure that the customer has viewing rights to the premium mobile content beyond his/her initial content viewing. In this respect, the second type of authentication incorporates dual or redundant authentication process steps (i.e., cookie and customer ID). Dual authentication is desirable because cookies are easily lost or unusable. The customer ID comparison acts as a backup authentication or validation step if the system fails to find a cookie (cookie become lost or unusable).

FIG. 4 illustrates text message 500 with a purchase notification. The message incorporates an html (http:// . . . ) link to a receipt stored on mobile billing server 26. The message also includes minimal text such as “Thank you for your purchase.” FIG. 5 illustrates receipt 600. In the receipt heading, it states “Thank you for your purchase.” Under that heading, a product is identified along with the amount. Several links are also provided. The receipt includes a content link (adjacent “View Content”). The customer clicks on this link to view the purchased premium content. Under the Customer Service heading (section), a FAQ link directs the customer to a page with product information and answers to commonly asked questions. There is also a Billing Company link to the billing company's page for billing and contact information. Below that, there is transaction #:123456. This is the unique ID for the transaction. This number is used as the receipt ID. A date of purchase also appears in the receipt. The receipt may include additional information if desired. FIGS. 4 and 5 are embodiments of the text message notification and receipt. However, alternative variations exist.

In FIG. 6, there is shown customer account information entry page 700. A banner is displayed on the top entitled “Fun & Sun Mobile.” Any banner may be used relating to the mobile content provider. Below that banner, the page has several boxes or fields in which a customer must enter information if the customer desires premium mobile content. For $19.99 as it states, a customer can purchase an all access pass. In this embodiment, the pass will be recurring and the customer's credit card will be charged until cancelled. The customer must enter his/her name as it appears on credit card, credit card type, card number, expiration date, mobile number, carrier network and email address in the appropriate boxes or fields. In addition, there is a box or field that a customer must check to agree with the terms and conditions. The web page shown in FIG. 6 is an embodiment of a customer account information page. Other alternative embodiments exist in keeping with the invention.

The foregoing description of embodiments of the invention has been presented for purposes of illustration and description. It is not intended to be exhaustive or to limit the invention to the precise form disclosed and modifications and variations are possible in light of the above teachings or may be acquired from practice of the invention. The embodiment was chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and their equivalents.

We claim:

1. A method of billing for mobile content purchased by a customer, the method comprising the step of generating a text message with a notification relating to a purchase by a customer of mobile content, the text message including a web link linking the text message to a receipt with information relating to the purchase of the mobile content.

2. The method of claim 1 wherein the receipt includes a web link linking the receipt to the mobile content.

3. The method of claim 2 further comprising the steps of forwarding the text message to a mobile device of the customer and charging a credit card of the customer after the customer has successfully received the receipt.

4. The method of claim 1 further comprising the steps of forwarding the text message to a mobile device of the customer and authenticating the customer's right to view the mobile content.

5. The method of claim 4 further comprising the step of authenticating the customer's right to view the mobile content a second time.

6. The method of claim 1 wherein the text message is one of a WAP push, an SMS and an SMTP text message.

7. A method of billing for mobile content, the method comprising the steps of:
receiving payment information from a customer for the purchase of mobile content;
processing the customer payment information;
authenticating automatically the customer's right to view the mobile content prior to the customer's receipt of the mobile content.

8. The method of claim 7 further comprising the step of sending a text message to a mobile device of the customer as a notification of the purchase of the mobile content after the step of processing, the text message including a web link linking the message to a receipt relating to the purchase of the mobile content, the receipt including a web link linking the receipt to the mobile content.

9. The method of claim 7 further comprising the step of generating a receipt relating to the purchase, the receipt including a receipt ID.

10. The method of claim 9 wherein the step of authenticating includes the steps of:
searching for an ID, stored in a database, assigned to the purchase that matches the receipt ID; and
sending the mobile content to the customer's mobile device for viewing if a match is found.

11. The method of claim 7 further comprising the step of authenticating automatically the customer's right to view the mobile at least a second time.

12. The method of claim 11 wherein the step of authenticating automatically the customer's right to view the mobile content at least a second time comprises the steps of:
installing a cookie within a browser on the customer's mobile device, the cookie including information relating the mobile content purchased and the date in which the cookie shall expire;
sending the mobile content to the customer's mobile device for viewing if the identity of the mobile content sent matches the identity of the content purchased in the cookie; and
removing the cookie from the browser following the expiration date.

13. The method of claim 11 wherein the step of authenticating automatically the customer's right to view the mobile content at least a second time comprises the step of using an ID that identifies the customer to validate the customer's right to view the mobile content in the event the cookie does not exist in the browser.

14. A method of supplying mobile content to a mobile device of a customer, the steps of the method comprising:
receiving customer payment information for the purchase of mobile content; and
transmitting a text message to the customer's mobile device as a notification of approval of the purchase, the message including a web link linking the message to a receipt relating to the purchase, the web link in the message thereby enabling the customer to view the receipt through the customer's mobile device,
the receipt including a receipt ID relating to the purchase and a web link linking the receipt to the purchased mobile content, the web link in the receipt thereby enabling the customer to view the purchased mobile content through the customer's mobile device.

15. The method of claim 14 further comprising the step of searching for an ID stored in a database and assigned following approval of the customer payment information that matches the receipt ID, and sending the mobile content to the customer's mobile if a match is found.

16. The method of claim 15 further comprising the step of installing a cookie in a browser of the customer's mobile device, the cookie having information that identifies the mobile content purchased and the date upon which the cookie will be deleted.

17. The method of claim 16 further comprising the step of sending the mobile content to the customer's mobile device if the identity of the mobile content sent matches the identity of the mobile content in the cookie.

18. The method of claim 17 further comprising the step of using an ID that identifies the customer to validate the customer's right to view the mobile content in the event the cookie does not exist in the browser.

19. A method for supplying mobile content to a mobile device of a customer, the method comprising the steps of:
receiving customer credit card information to purchase the right to view the mobile content through the customer's mobile device;
transmitting a text message to a customer's mobile device, the message including a web link linking the message to a receipt relating to the purchase, the link thereby enabling the customer to view a receipt through the customer's mobile device, the receipt including a web link linking the receipt to the mobile content, the web link thereby enabling the customer to view the mobile content through the customer's mobile device; and
charging the customer's credit card for the right to view the mobile content only when the customer has successfully viewed the receipt on the customer's mobile device.

20. The method of claim 19 wherein the credit card information is received via a web site.

21. The method of claim 19 wherein the credit card information is received via a phone.

22. A billing system for mobile content purchased by a customer, the system comprising:
a server forwarding a text message to a mobile device of the customer, the text message including a notification approving a purchase by the customer of mobile content.

23. The billing system of claim 22 wherein the server generates a receipt relating to the purchase, the receipt including a web link linking the receipt to the mobile content purchased.
